(19) United States
(12) Patent Application Publication
(10) Pub. No.: US 2013/0151528 A1
(43) Pub. Date: Jun. 13, 2013

(54) LOGGING DEVICE, LOGGING SYSTEM AND CONTROL METHOD FOR LOGGING DEVICE

(71) Applicants: Weihau Lee, Chiyoda-ku (JP); Naoyuki Aoyama, Chiyoda-ku (JP)

(72) Inventors: Weihau Lee, Chiyoda-ku (JP); Naoyuki Aoyama, Chiyoda-ku (JP)

(73) Assignee: MITSUBISHI ELECTRIC CORPORATION, Chiyoda-ku, TOKYO (JP)

(21) Appl. No.: 13/698,174

(22) PCT Filed: May 28, 2010
(86) PCT No.: PCT/JP2010/003600

§ 371 Date: Feb. 1, 2013

(51) Int. Cl. G06F 17/30

(52) U.S. Cl. CPC G06F 17/30705
USPC 707/737

(57) ABSTRACT

A logging device of the present invention includes a collection unit for correlating a production data obtained from a production apparatus with an identification data specific to a product produced by the production apparatus and for collecting these data; and an output unit for outputting the identification data collected by the collection unit to a traceability file and for outputting the production data collected by the collection unit into an area in the traceability file, corresponding to the identification data correlated with the production data. According to the present invention, processing loads to the logging device can be reduced in creating a traceability file, and a traceability file can be created without requiring a particular memory area for storing data collected by the logging device.

### TECHNICAL FIELD

The present invention relates to a logging device and a logging system that collect data handled in a production process, and to a control method for the logging device.

### BACKGROUND ART

In manufacturing industries, in order to achieve traceability in production processes of products, performance management of production processes is sometimes performed by establishing correlation between a measurement data handled in production processes and an identification data specific to the measured object, and by collecting the data. There is a conventional data collection system, in which a slave collection unit collects a measurement data with it being correlated with a lot number specific to the measured object, to transmit the measurement data to a master collection unit; and the master collecting unit creates a data record that stores on a lot number basis a plurality of measurement data correlated with the same lot number, to accumulate the record in a database (for example,

Patent Document 1).

### PRIOR ART DOCUMENT

### Patent Document

Patent Document 1: JP 2006-217549A

### SUMMARY OF THE INVENTION

### Problem that the Invention is to Solve

Recently, there is a case where a file (hereinafter, referred to as a “traceability file”) is created that has a format in which a plurality of production data each correlated with an identification data specific to a product are separated on an identification data-item basis, and performance management of a production process is performed using the created traceability file. Using such a traceability file, the data management can be performed easier.

If a traceability file is created using a database in a data collection system disclosed in Patent Document 1, a data record stored in the database is extracted and output to the traceability file. However, if the traceability file is updated every time a data record is updated, a problem is raised in that the system undergoes large processing loads due to frequent extraction of data records and update of the traceability file. In a case with a traceability file that is made up of a text file in particular, since attempt to update a part of data entails update of a portion other than that to be updated, this raises a problem of further increasing the processing loads to the system. In addition, a memory area for the database is required in the case with Patent Document 1, causing a problem of increasing costs of the system as well as reducing processing efficiency thereof.

On the other hand, a method is conceivable in which a file (hereinafter referred to as a “chronological file”) is created that has a format in which measurement data and identification data are output in collection order thereof, and a traceability file is created without using a database by extracting data from the created chronological file. However, this method also poses problems of increasing processing loads to the system and requiring a memory area for the chronological file.

### Means for Solving the Problem

A logging device according to the present invention is characterized by including a collection unit for correlating a production data obtained from a production apparatus with an identification data specific to a product produced by the production apparatus and for collecting these data; and an output unit for outputting the identification data collected by the collection unit to a traceability file and for outputting the production data collected by the collection unit into a area in the traceability file, corresponding to the identification data correlated with the production data.

A logging device according to the present invention is characterized by including an external device for correlating a production data obtained from a production apparatus with an identification data specific to a product produced by the production apparatus and for collecting these data; and the logging device for collecting, based on predetermined setting contents, part of or all of the production and identification data from the external device.

A logging device control method according to the present invention is characterized by including a collecting step of correlating a production data obtained from a production apparatus with an identification data specific to a product produced by the production apparatus, and collecting these data; an output location searching step of determining whether or not the identification data is output to a traceability file; an identification data outputting step of outputting the identification data to the traceability file when the identification data is determined, in the output location searching step, to be not output to the traceability file; and a production data outputting step of outputting the production data correlated with the identification data into an area corresponding to the identification data.

### Advantages of the Invention

According to the present invention, processing loads to a logging device can be reduced in creating a traceability file. Furthermore, a traceability file can be created without requiring a particular memory area for storing a data collected by the logging device.

### BRIEF DESCRIPTION OF THE DRAWINGS

FIG. 1 is a block diagram showing a configuration of a logging system in Embodiment 1;

FIG. 2 is a block diagram showing an internal configuration of an output unit in Embodiment 1;

FIG. 3 is a flow chart showing an outline of processing of the logging system in Embodiment 1; and

FIG. 4 is a flow chart showing processing of the output unit in Embodiment 1.

### REFERENCE NUMERALS

1: logging device
3: programmable logic controller
4: production apparatuses
12: collection unit
13: output unit
15: traceability file
100: output location search unit
104: identification data output unit
105: production data output unit
103: dummy data output unit

### BEST MODE FOR CARRYING OUT THE INVENTION

### Embodiment 1

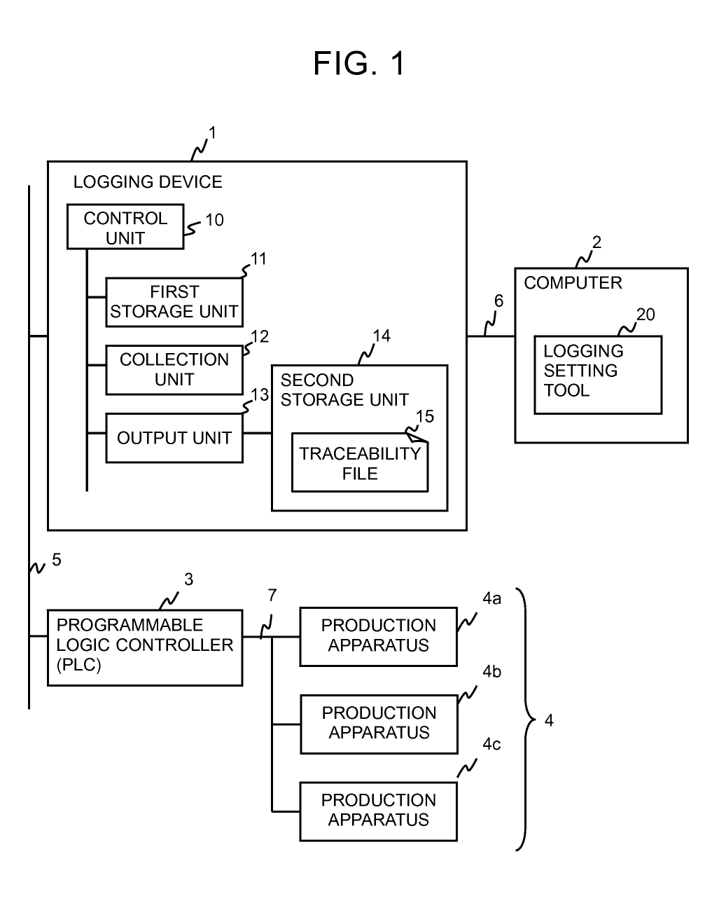

Embodiment 1 of the present invention will be described with reference to FIGS. 1 through 4.

FIG. 1 is a block diagram showing a configuration of a logging system in Embodiment 1. The logging system in Embodiment 1 includes a logging device 1, a computer 2, a programmable logic controller (PLC) 3, and production apparatuses 4. The logging device 1 and the PLC 3 are connected with each other via an internal bus 5. The computer 2 is connected to the logging device 1 through a cable 6 such as for the Ethernet™.

The production apparatuses 4 are connected to the PLC 3 through a cable 7 such as for Ethernet™. In the present embodiment, the production apparatuses 4 are constituted with three production apparatuses 4a, 4b, and 4c, and a product is produced though each production process of the production apparatuses 4. In the present embodiment, the production apparatus 4a performs a machining process, the production apparatus 4b performs a cleaning process, and the production apparatus 4b performs an inspection process.

The PLC 3 controls the production apparatuses 4 in accordance with a program stored internally, and collects at predetermined time intervals (for example, 10 ms interval) a production data obtained from each of the production apparatuses 4 and an identification data specific to a product produced by the production apparatuses 4 and holds these data. In the present embodiment, the production data collected from the production apparatus 4a is a measurement value of a processing pressure, the production data collected from the production apparatus 4b is a measurement value of a cleaning temperature, and the production data collected from the production apparatus 4c is a measurement value of an inspection strength. The identification data referred to in the present embodiment is a serial number that is individually given to each product produced by the production apparatuses 4. In addition, the identification data may be collected from a not-shown identification data reading means.

The computer 2 has a logging setting tool 20 made up of software. The logging setting tool 20 creates logging setting data by a user operation of the computer 2. The logging setting data is data concerning setting contents such as contents of data to be collected by the logging device 1 from the PLC 3, a condition for collecting data, a timing for collecting data, and a layout of a traceability file 15. In addition, the computer 2 may be disconnected from the logging device 1 after transmitting the logging setting data to the logging device 1.

In the present embodiment, it is set as a condition for collecting data that the production apparatuses 4a, 4b, and 4c connected to the PLC 3 is in operation. Moreover, respective production data corresponding to the production apparatuses 4a, 4b, 4c and respective identification data of products produced by the production apparatuses 4 are set as contents of data to be collected. Furthermore, time points when the production apparatuses 4a, 4b, and 4c finish their respective production processes are set as timings for collecting data.

The logging device 1 includes a control unit 10 such as a microcomputer for controlling the operation of the logging device 1, a first storage unit 11, a collection unit 12, an output unit 13, and a second storage unit 14.

The first storage unit 11 is a storage means that is provided beforehand in the logging device 1 and made up of, for example, a ROM, a RAM or the like. The first storage unit 11 beforehand stores a system program. The control unit 10 performs operations of the collection unit 12 and the output unit 13 by executing the system program stored in the first storage unit 11. Furthermore, when the logging device 1 receives the logging setting data from the computer 2, the first storage unit 11 stores the received logging setting data.

The collection unit 12 collects a production data and an identification data from the PLC 3 on the basis of the logging setting data stored in the first storage unit 11. At this time, the collection unit 12 establishes correlation between the production data corresponding to each production apparatus 4a, 4b, or 4c and the identification data of the product, and collects these data.

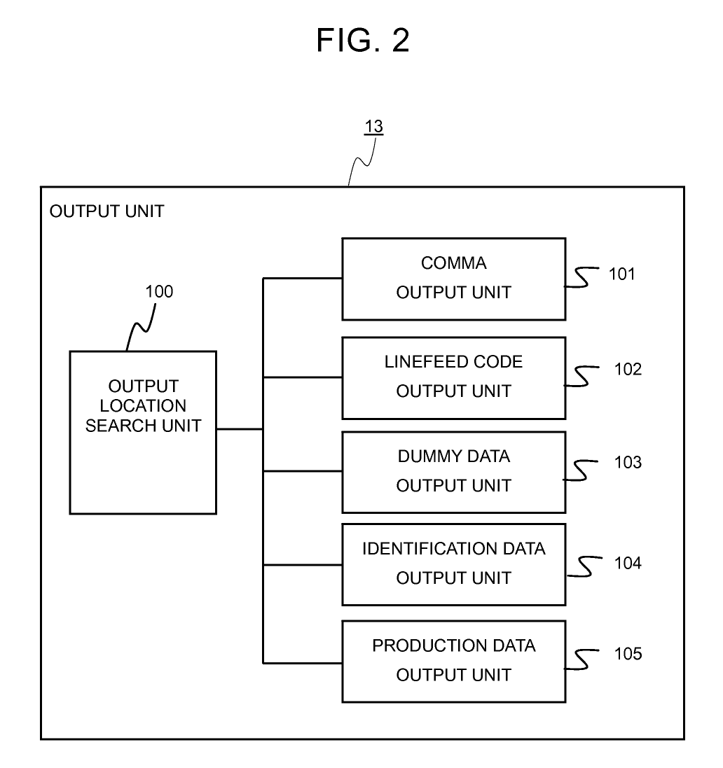

The output unit 13 creates a traceability file 15 based on the logging setting data stored in the first storage unit 11, the production data and the identification data collected from the collection unit 12. FIG. 2 is a block diagram showing an internal configuration of the output unit in Embodiment 1. The output unit 13 includes an output location search unit 100, a comma output unit 101, a linefeed code output unit 102, a dummy data output unit 103, an identification data output unit 104, and a production data output unit 105.

The output location search unit 100 searches the traceability file 15 for a location for a production data to be output and determines the location. The comma output unit 101, the linefeed code output unit 102, and the dummy data output unit 103 output a comma, a linefeed code, and a dummy data, respectively, to the traceability file 15. The identification data output unit 104 outputs an identification data to the end of the traceability file 15. The production data output unit 105 outputs the production data into the location determined by the output location search unit 100.

The second storage unit 14 is a storage means that is removably attached to the logging device 1, and includes, for example, a compact flash™, a memory card, or the like. The second storage unit 14 has a memory area sufficient to store the traceability file 15. The traceability file 15 in the present embodiment is a text file of a comma-separated values (CSV) form for storing a production data with it being correlated with its corresponding identification data and its corresponding one of the production apparatuses 4. A layout of the traceability file 15 of the present embodiment is shown in Table 1 below. Note that Table 1 shows a tabular form converted from the CSV form, of a half-created state of the traceability file 15.

TABLE 1

| | production | production | production |
|---|---|---|---|
| | apparatus 4a | apparatus 4b | apparatus 4c |
| identification data1 | production data 1a | production | production |
| | | data 1b | data 1c |
| identification data 2 | production data 2a | production | dummy data |
| | | data 2b | |
| identification data 3 | production data 3a | dummy data | dummy data |

In Table 1 showing the traceability file 15, the three rows correspond to an “identification data 1”, an “identification data 2”, and an “identification data 3”, respectively, and the three columns correspond to the production apparatus 4a, the production apparatus 4b, and the production apparatus 4c, respectively. In the cells in the row corresponding to the “identification data 1” and in the columns corresponding to the respective production apparatus 4a, the production apparatus 4b, and the production apparatus 4c, stored are a “production data 1a”, a “production data 1b”, and a “production data 1c”, respectively. In the cells in the row corresponding to the “identification data 2” and in the columns corresponding to the respective production apparatus 4a and production apparatus b, stored are a “production data 2a” and a “production data 2b”, respectively, and in the cell in the same row and in the column corresponding to the production apparatus 4c, stored is a dummy data. In the cell in the row corresponding to the “identification data 3” and in the column corresponding to the production apparatus 4a, stored is a “production data 3a”, and in the cells in the same row and in the columns corresponding to the respective production apparatus 4b and production apparatus 4c, stored are dummy data.

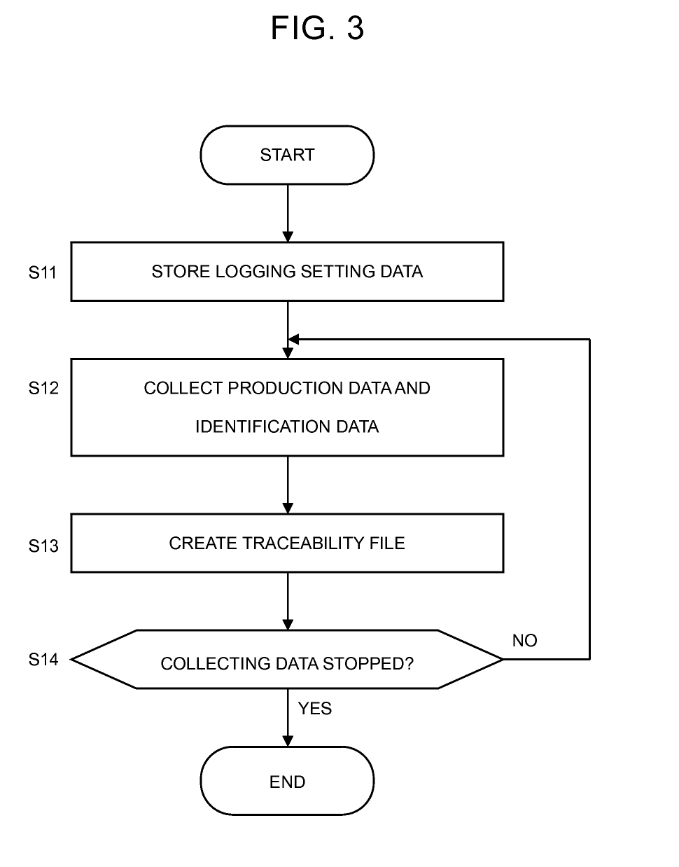

Next, processing of the logging device in Embodiment 1 will be described. FIG. 3 is a flow chart showing an outline of processing of the logging system in Embodiment 1. The logging setting tool 20 creates logging setting data by user's pre-operation on the computer 2. When the logging setting data is afterwards transmitted from the computer 2 to the logging device 1, the first storage unit 11 stores the logging setting data (Step S11).

Next, the collection unit 12 collects a production data and an identification data from the PLC 3 on the basis of the logging setting data stored in the first storage unit 11 (Step S12). Next, the output unit 13 creates a traceability file 15 based on the logging setting data stored in the first storage unit 11 and on the production data and the identification data collected in S2 from the collection unit 12 (Step S13). Note that processing of the output unit 13 will be described in detail later.

Next, the logging device 1 determines whether or not the collection unit 12 has stopped collecting production data and identification data (Step S14). When the collection unit 12 has not stopped collecting production data and identification data, the process returns to S12. On the other hand, when the collection unit 12 has stopped collecting production data and identification data in S14, the process terminates. In the present embodiment, when the production apparatuses 4 stop their operations, the collection unit 12 also stops collecting production data and identification data.

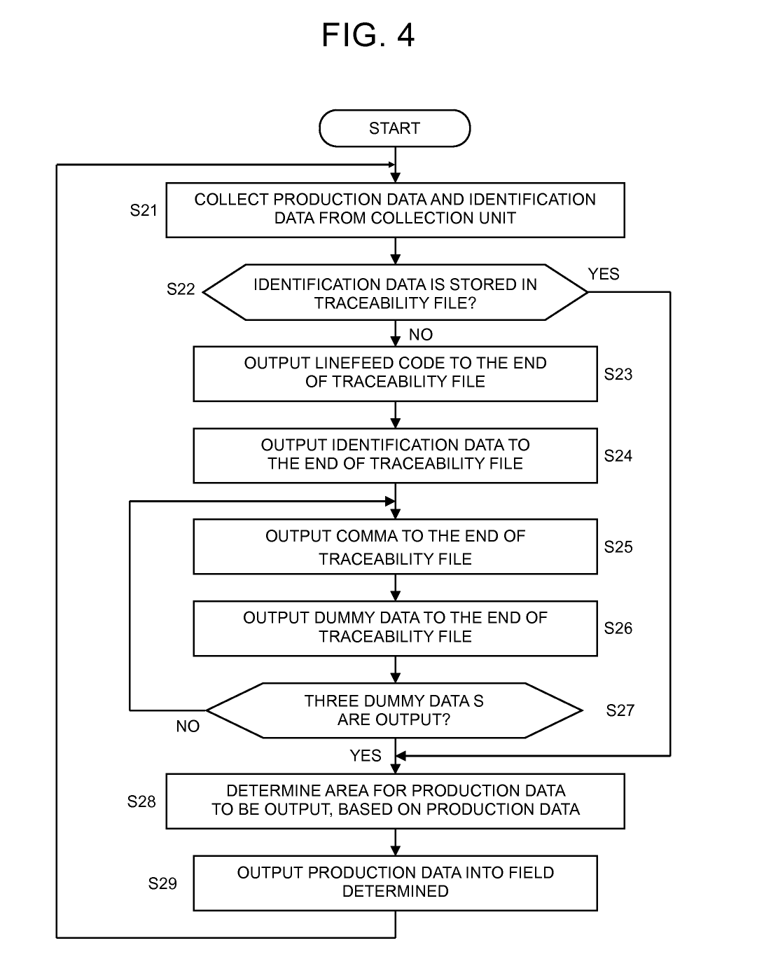

FIG. 4 is a flow chart showing processing of the output unit 13 in Embodiment 1. The processing of the output unit 13 shown in FIG. 4 corresponds to Step S13 in FIG. 3.

First, the output unit 13 collects the production data and the identification data collected by the collection unit 12 (Step S21). Next, the output location search unit 100 determines whether or not the identification data collected in S21 has already been stored in the traceability file 15 (Step S22). If it is determined in Step S22 that the identification data collected in S21 has been stored in the traceability file 15, then the output unit 13 proceeds to S28.

On the other hand, if the output location search unit 100 determines in Step S22 that the identification data collected in S21 has not been stored in the traceability file 15, then the linefeed code output unit 102 outputs a linefeed code to the end of the traceability file 15 (Step S23). Thereby, a new line is added to the end of the traceability file 15. It should be noted that if a traceability file 15 is newly created and stores no data, S22 or S23 may be skipped.

Next, the identification data output unit 104 outputs the identification data collected in Step S21 to the end of the traceability file 15 (Step S24). Thereby, the identification data collected in Step S21 is added to the beginning of the new line added in Step S23.

Next, the comma output unit 101 outputs a comma to the end of the traceability file 15 (Step S25). Thereby, a new column is added to the line added newly in Step S23. Next, the dummy data output unit 103 outputs a dummy data to the end of the traceability file 15 (Step S26). Thereby, the dummy data is added to the column added newly in Step S25. An area for storing a production data can be allocated to the cell in this way. A dummy data used here is a data such as of a character string, for example, composed of a plurality of space characters that is able to be clearly distinguished from a production data by a user.

Next, the output unit 13 determines whether or not a dummy data has been stored in all three areas in the line added newly in Step S23 and in the columns corresponding to the respective production apparatuses 4a, 4b, 4c (Step S27). If a dummy data has not been stored in all the three areas in Step S27, the procedure returns to Step S25 and Steps S25 through S26 are repeated until the dummy data is stored in the three areas in the line added newly in Step S23.

On the other hand, if in Step 27, the dummy data is stored in the three areas in the line added newly in Step S23, then the output location search unit 100 determines, based on the production data collected in Step S21, a location for the production data to be output (Step S28). Here, the output location search unit 100 identifies one of the production apparatuses 4 that outputs the production data collected in Step S21 and then determines, as a location for the production data to be output, an area whose column corresponds to the identified one of the production apparatuses 4 and whose row corresponds to the identification data collected in Step S21. As a method of identifying one of the production apparatuses 4 that outputs its production data, for example, information for identifying the one of the production apparatuses 4 may be included in the production data or the PLC 3 may attach identification information of the one of the production apparatuses 4 to the production data when receiving the production data from the one of the production apparatuses 4.

Next, the production data output unit 105 outputs the production data collected in Step S21 to the location determined in Step S28 for the production data to be output (Step S29). At this time, the production data output unit 105 replaces with the production data the dummy data having already been stored in the area determined as the output location in Step S28. After that, the output unit 13 returns to Step S21.

According to Embodiment 1, a data collected by a logging device can be output directly to a traceability file. This reduces processing loads to the logging device as well as eliminates the need for providing a particular memory area for storing the data collected by the logging device.

According to Embodiment 1, when only a part of data in the traceability file is modified, only the part of data to be modified can be modified without changing a portion of the data other than that to be modified. This allows for reducing processing loads to the logging device. In a case of the traceability file shown in Table 1, for example, before the “production data 2c” corresponding to the “identification data 2” and the production apparatus 4c is collected, an area for storing the production data is allocated with a dummy data. This allows for storing the “production data 2c” in the area whose row corresponds to the “identification data 2” and whose column corresponds to the identified production apparatus 4c without changing other area for a production data or an identification data when the “production data 2c” is collected.

It should be noted that, in the present embodiment, the logging device 1 and the PLC 3 are connected with each other through the internal bus 5, the both may be connected through a cable such as for Ethernet™.

In the present embodiment, the logging device 1 collects a production data and an identification data from one of the production apparatuses 4 via the PLC 3, but collection of data is not limited to this. For example, the logging device 1 may collect a production data and an identification data from one of the production apparatuses 4 via a device other than PLCs or may collect a production data and an identification data directly from one of the production apparatuses 4.

In the present embodiment, the output unit 13 of the logging device 1, when receiving a new identification data, outputs a dummy data to the traceability file, but the output timing is not limited to this. That is, the output unit 13 of the logging device 1 may output the dummy data to the traceability file before receiving the new identification data. For example, the output unit 13 beforehand creates a traceability file that has stored dummy data in areas for storing an identification data and a production data, and later the collection unit 12 may collects an identification data and a production data. Otherwise, a traceability file having stored dummy data in areas for storing an identification data and a production data is beforehand stored in the second storage unit 14, and later the collection unit 12 may collects an identification data and a production data.

A traceability file in the present embodiment is a text file, but is not limited to this. For example, the traceability file may be a binary file.

An identification data in the present embodiment is specific to a product, but not limited to this. For example, the identification data may be specific to a batch or a lot.

In the present embodiment, the first storage unit 11 is a storage means that is beforehand built-in in the logging device 1 and the second storage unit 14 is a storage means that is removably attached to the logging device 1, but a device configuration is not limited to this. For example, the first storage unit 11 may be a storage means that is removably attached to the logging device 1, and the second storage unit 14 may be a storage means that is beforehand built-in in the logging device 1.

1-9. (canceled)

10. A logging device comprising:
a collection unit for correlating respective production data items obtained from a plurality of production apparatuses with an identification data item specific to a product produced by the plurality of respective production apparatuses, and for collecting these items;
an identification data output unit for determining whether or not the identification data item collected by the collection unit has been output to a traceability file that is a text file or a binary file, and for outputting the identification data item to the traceability file when determining that the identification data item has not been output to the traceability file;
a dummy data output unit for outputting a dummy data item into a field in the traceability file, corresponding to each production apparatus and to the identification data item output by the identification data output unit; and
a production data output unit for replacing with each production data item the dummy data item output by the dummy data output unit into the field in the traceability file, corresponding to each production apparatus from which the production data items are obtained and to the identification data item collected with it being correlated with the production data items.

11. The logging device of claim 10, further comprising a first storage unit for storing first setting data concerning setting contents including a specification of the production data items, a condition for collecting the production data items and/or a timing for collecting the production data items, wherein the collection unit collects based on the first setting data the production data items and the identification data item.

12. The logging device of claim 10, further comprising a second storage unit for storing second setting data concerning a setting content of a layout in the traceability file, wherein the output unit outputs based on the second setting data the production data items and the identification data item to the traceability file.

13. The logging device of claim 10, wherein the traceability file beforehand stores the dummy data item into each field for the production data items and the identification data item to be stored, and the production data output unit replaces with each production data item the dummy data item beforehand stored in the field corresponding to each production apparatus from which the production data items are obtained and to the identification data item collected with it being correlated with the production data items.

14. A logging system comprising:
an external device for correlating respective production data items obtained from a plurality of production apparatuses with an identification data item specific to a product produced by the plurality of respective production apparatuses, and for collecting these items; and
the logging device of claim 10 for collecting, based on predetermined setting contents, part of or all of the production and identification data items from the external device.

15. A method of controlling a logging device, comprising:
a collecting step of correlating respective production data items obtained from a plurality of production apparatuses with an identification data item specific to a product produced by the plurality of respective production apparatuses, and collecting these items;
an identification data outputting step of determining whether or not the identification data item collected in the collecting step has been output to a traceability file that is a text file or a binary file, and outputting the identification data item to the traceability file when determining that the identification data item has not been output to the traceability file;
a dummy data outputting step of outputting a dummy data item into a field in the traceability file, corresponding to each production apparatus and to the identification data item output in the identification data outputting step; and
a production data outputting step of replacing with each production data item the dummy data item output in the dummy data outputting step into the field in the traceability file, corresponding to each production apparatus from which the production data items are obtained and to the identification data item collected with it being correlated with the production data items.
